(19) United States
(12) Patent Application Publication
(10) Pub. No.: US 2026/0053263 A1
(43) Pub. Date: Feb. 26, 2026

(54) TONGUE CLEANER

(71) Applicant: Wenzhou Yunshang Biological Technology Co., Ltd., Wenzhou (CN)

(72) Inventor: Yun ZHANG, Wenzhou (CN)

(21) Appl. No.: 19/376,235

(22) Filed: Oct. 31, 2025

(30) Foreign Application Priority Data
Oct. 16, 2025 (CN) 202511480074.4

(51) Int. Cl. A46B 15/00; A46B 5/00; A46B 11/00; A61C 19/06

(52) U.S. Cl. CPC A46B 15/0081; A46B 5/0012; A46B 5/0095; A46B 11/002; A46B 11/0075; A46B 11/0086; A46B 2200/10; A61C 19/063

(57) ABSTRACT

A tongue cleaner is provided, including a handle and a brush head. The brush head is composed of an outer brush plate and an inner brush plate. A scraping groove formed between the outer brush plate and the inner brush plate can efficiently clear a tongue coating. An accommodation tank and a movable hole are formed in the inner brush plate. A bead may be accommodated in the accommodation tank. A puncturing member is slidably mounted on the handle. An end thereof may enter the movable hole and extrude the bead to release an internal liquid component. In the present disclosure, a unique double-layer brush plate structure and a puncturing release mechanism of a built-in bead are used to implement synchronization between physical scraping and liquid nursing, thereby effectively improving a cleaning effect and user experience.

### TECHNICAL FIELD

The present disclosure relates to technical field of toothbrushes, in particular to a tongue cleaner.

### BACKGROUND

Keeping the tongue clean is an important part of oral hygiene. The tongue coating composed of mixtures such as bacteria, food residue, and cast-off cells not only is a major cause of halitosis, but also may affect taste perception, and even becomes a cause of oral flora imbalance.

Currently, there are two types of common tongue cleaning tools on the market. The first type is a conventional tongue scraper or a tongue brush, which generally uses a single scraping plate or a brush head to clear the tongue coating by means of physical scraping. Although the structure is simple, the functions of this type of tools are single, and bactericidal, refreshing or nursing effects cannot be provided while cleaning. The user experience needs to be improved.

The second type is some products that attempt to combine liquid cleaning. For example, the care solution is pre-immersed in the brush head or separate mouthwash is provided for the user. However, there are obvious defects in such a manner. The effective components of the pre-immersed solution are volatilized over time, and the effect is difficult to endure. However, steps are cumbersome in cooperation with the mouthwash, which fails to synchronize and integrate cleaning and nursing.

Therefore, there is an urgent need in the art for an integrated tongue cleaner that deeply combines mechanical cleaning with immediate liquid caring.

### SUMMARY

The purpose of the present disclosure is to provide a tongue cleaner in order to solve the defects and shortages in the prior art.

To implement the foregoing purpose, the present disclosure provides the following technical solutions. A tongue cleaner includes a handle and a brush head disposed at an end thereof, where an accommodation tank configured to accommodate a bead and a movable hole in communication with the accommodation tank are formed in the brush head, a puncturing member is slidably mounted on the handle, and an end thereof may enter the movable hole and squeeze the bead in the accommodation tank.

As a preferred technical solution of the present disclosure, the brush head includes an outer brush plate and an inner brush plate; the outer brush plate and the handle are connected and are jointly enclosed to form a mounting groove; the inner brush plate is connected to the outer brush plate or the handle and is suspended in the mounting groove, and a scraping groove is formed between the inner brush plate and the outer brush plate.

As a preferred technical solution of the present disclosure, the inner brush plate and the handle are connected and are jointly enclosed to form a through groove; the movable hole is formed in a side wall that is of the inner brush plate and that faces the through groove; and at least a part of the puncturing member is located in the through groove.

As a preferred technical solution of the present disclosure, the puncturing member includes a connecting seat slidably connected to the handle and an extrusion plate fastened to the connecting seat and located in the through groove, and the extrusion plate corresponds to a position of the movable hole.

As a preferred technical solution of the present disclosure, the accommodation tank includes two bead holes disposed side by side and in communication with each other; and a recess is disposed in the middle of one end that is of the extrusion plate and that faces the movable hole, and extrusion protrusions corresponding to positions of the two bead holes are formed on two sides thereof.

As a preferred technical solution of the present disclosure, a socket with a U-shaped cross section is disposed on the connecting seat, and a front end of the handle is provided with a plugging portion that is in sliding fit with the socket.

As a preferred technical solution of the present disclosure, a positioning groove is disposed on the plugging portion, and a positioning protrusion that is in clamping fit with the positioning groove is disposed on an inner wall of the socket; and when the positioning protrusion is clamped with the positioning groove, an end of the extrusion portion is located outside the movable hole.

As a preferred technical solution of the present disclosure, hooks are disposed on two sides of a front end of the handle, and slots that are adapted to the hooks in shapes are disposed on two ends of the inner brush plate.

As a preferred technical solution of the present disclosure, a cavity is disposed in the handle, and a cover configured to close an opening of the cavity is connected to one end that is of the handle and that is relatively away from the brush head.

As a preferred technical solution of the present disclosure, the outer brush plate includes a curved scraper portion and a pair of connecting arms connected to two sides of the scraper portion, and the outer brush plate is connected to the handle by using the connecting arms; and plugging holes are respectively formed in two sides of a front end of the handle, and plugging plates that are adapted to the plugging holes in shapes are respectively disposed on ends of the two connecting arms.

In conclusion, the present disclosure has the following beneficial effects. Efficient cutting and scraping effects are generated on the tongue coating in a reciprocating movement by using the brush head. In addition, the puncturing member can immediately release a liquid nursing component (such as a refreshing agent, a bactericide, or a probiotics) in the bead, a perfect combination of mechanical cleaning and chemical nursing is implemented, and oral hygiene is improved fundamentally. The puncturing member can implement precise stroke control by sliding connection and positioning protrusion/groove structures. In a non-use state, the end of the extrusion plate is located outside the movable hole to avoid false touch and contamination. In use, a puncturing action can be completed by simply pushing, and the operation is convenient and hygienic.

### BRIEF DESCRIPTION OF THE DRAWINGS

FIG. 1 is a structural schematic diagram according to the present disclosure;

FIG. 2 is a structural schematic diagram of a brush head part according to the present disclosure;

FIG. 3 is a cooperative structural schematic diagram of an inner brush plate and a puncturing member according to the present disclosure;

FIG. 4 is a structural schematic diagram of an inner brush plate according to the present disclosure;

FIG. 5 is a structural schematic diagram of a puncturing member according to the present disclosure;

FIG. 6 is a structural schematic diagram of an outer brush plate according to the present disclosure; and

FIG. 7 is a structural schematic diagram of a front end of a handle according to the present disclosure.

Reference numerals: 1: handle; 2: brush head; 3: accommodation tank; 4: movable hole; 5: puncturing member; 6: outer brush plate; 7: inner brush plate; 8: mounting groove; 9: scraping groove; 10: through groove; 11: connecting seat; 12: extrusion plate; 13: bead hole; 14: recess; 15: extrusion protrusion; 16: socket; 17: plugging portion; 18: positioning groove; 19: positioning protrusion; 20: hook; 21: slot; 22: scraper portion; 23: connecting arm; 24: plugging hole; 25: plugging plate; 26: cavity; and 27: cover.

### DETAILED DESCRIPTION OF THE EMBODIMENTS

In order to make the technical means, creative features, objectives, and effects of the present disclosure easily comprehensible, specific embodiments and accompanying drawings are combined below to further elaborate on the present disclosure. However, the following embodiments are merely preferred embodiments of the present disclosure and do not represent all embodiments. Other embodiments obtained by those skilled in the art based on the embodiments of the present disclosure without creative efforts shall fall within the protection scope of the present disclosure.

The following describes the embodiments of the present disclosure with reference to the accompanying drawings.

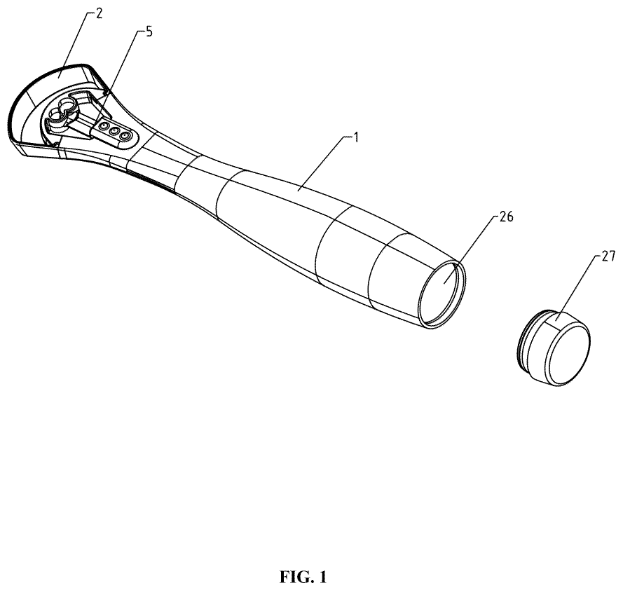

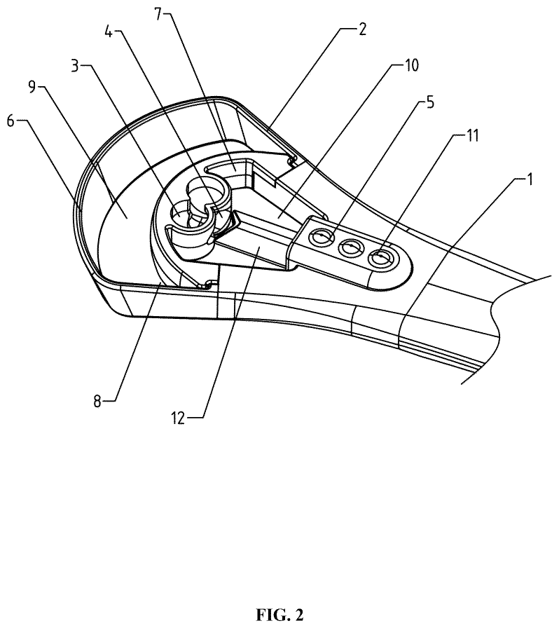

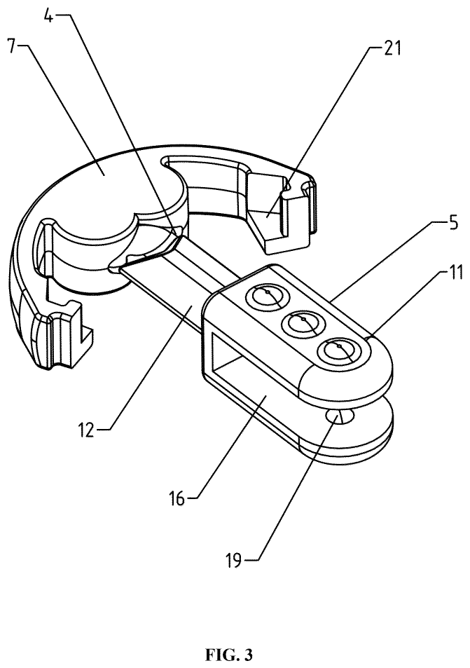

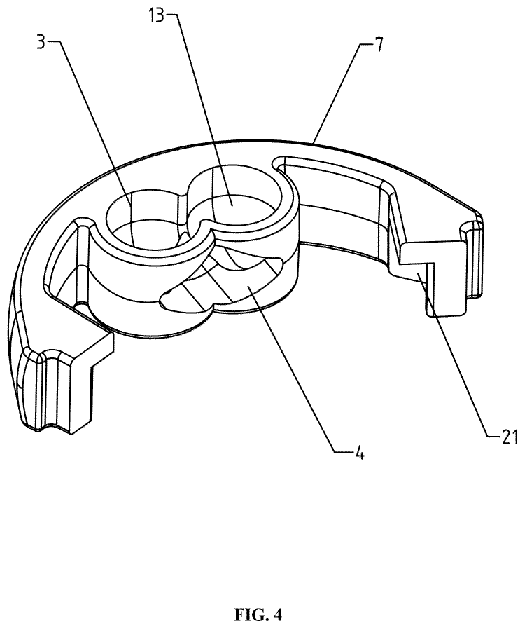

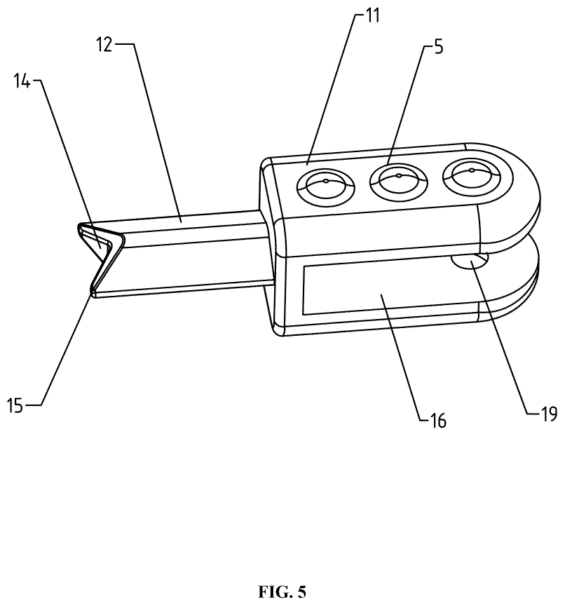

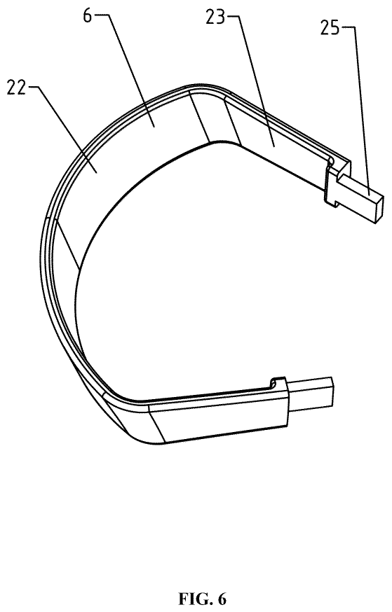

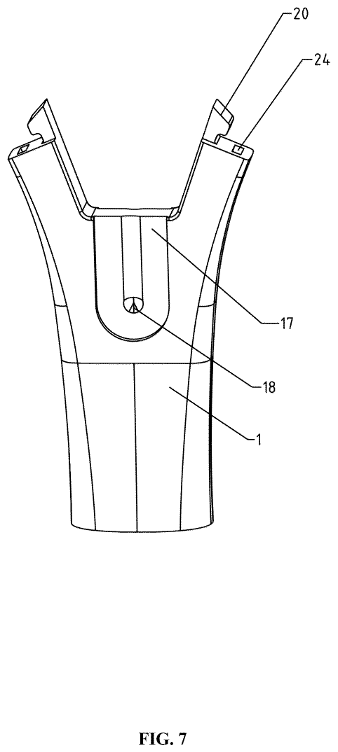

As shown in FIG. 1 to FIG. 7, a tongue cleaner includes a handle 1 and a brush head 2 disposed at an end thereof. The brush head 2 includes an outer brush plate 6 and an inner brush plate 7. The outer brush plate 6 and the handle 1 are connected and are jointly enclosed to form a mounting groove 8. The inner brush plate 7 is connected to the outer brush plate 6 or the handle 1 and is suspended in the mounting groove 8, and a scraping groove 9 is formed between the inner brush plate 7 and the outer brush plate 6. An accommodation tank 3 configured to accommodate a bead and a movable hole 4 in communication with the accommodation tank 3 are formed in the brush head 2. A puncturing member 5 is slidably mounted on the handle 1, and an end thereof may enter the movable hole 4 and squeeze the bead in the accommodation tank 3. As a preferred solution, when the brush head 2 moves on a tongue surface, a tongue body tissue and a tongue coating are partially embedded in the scraping groove 9, and a groove wall has an efficient cutting and scraping effect on inserts in a reciprocating movement, thereby significantly improving a cleaning effect on the stubborn tongue coating. For the form of the scraping groove 9, the scraping groove 9 may be a penetrating groove, or may be a locally disposed non-through groove 10. In addition, the concept of this design may also be extended: As an alternative solution, the structure of the scraping groove 9 may be omitted, and instead, a raised scraping plate or scraper is directly disposed on a surface of the brush head 2 to implement a cleaning function.

Efficient cutting and scraping effects are generated on the tongue coating in a reciprocating movement by using the brush head 2. In addition, the puncturing member 5 can immediately release a liquid nursing component (such as a refreshing agent, a bactericide, or a probiotics) in the bead, a perfect combination of mechanical cleaning and chemical nursing is implemented, and oral hygiene is improved fundamentally. The puncturing member 5 can implement precise stroke control by sliding connection and positioning protrusion 19/groove structures. In a non-use state, the end of the extrusion plate 12 is located outside the movable hole 4 to avoid false touch and contamination. In use, a puncturing action can be completed by simply pushing, and the operation is convenient and hygienic.

The inner brush plate 7 and the handle 1 are connected and are jointly enclosed to form a through groove 10. The movable hole 4 is formed in a side wall that is of the inner brush plate 7 and that faces the through groove 10. At least a part of the puncturing member 5 is located in the through groove 10.

The puncturing member 5 includes a connecting seat 11 slidably connected to the handle 1 and an extrusion plate 12 fastened to the connecting seat 11 and located in the through groove 10, and the extrusion plate 12 corresponds to a position of the movable hole 4.

The accommodation tank 3 includes two bead holes 13 disposed side by side and in communication with each other. A recess 14 is disposed in the middle of one end that is of the extrusion plate 12 and that faces the movable hole 4, and extrusion protrusions 15 corresponding to positions of the two bead holes 13 are formed on two sides thereof. The accommodation tank 3 is designed with two bead holes 13 side by side, and can accommodate two beads at the same time. By using the extrusion protrusions 15 on two sides of the extrusion plate 12, the two beads can be extruded at the same time, so that a liquid release amount is more sufficient, and a nursing effect is more significant and lasting. The present disclosure may relate to a single, two, or three bead holes 13 or more. A specific design is not specifically limited.

A socket 16 with a U-shaped cross section is disposed on the connecting seat 11, and a front end of the handle 1 is provided with a plugging portion 17 that is in sliding fit with the socket 16.

A positioning groove 18 is disposed on the plugging portion 17, and a positioning protrusion 19 that is in clamping fit with the positioning groove 18 is disposed on an inner wall of the socket 16; and when the positioning protrusion 19 is clamped with the positioning groove 18, an end of the extrusion portion is located outside the movable hole 4.

Hooks 20 are disposed on two sides of a front end of the handle 1, and slots 21 that are adapted to the hooks 20 in shapes are disposed on two ends of the inner brush plate 7. The outer brush plate 6 includes a curved scraper portion 22 and a pair of connecting arms 23 connected to two sides of the scraper portion 22, and the outer brush plate 6 is connected to the handle 1 by using the connecting arms 23. Plugging holes 24 are respectively formed in two sides of a front end of the handle 1, and plugging plates 25 that are adapted to the plugging holes 24 in shapes are respectively disposed on ends of the two connecting arms 23. The entire brush head 2 has a high degree of modularization, and the inner and outer brush plates 6 are connected to the handle 1 by using structures such as the hook 20, the slot 21, the plugging plate 25, and the plugging hole 24. An assembly relationship is clear and a connection is firm, so as to facilitate production and manufacture and replacement of the brush head 2 with the user. It should be understood that the foregoing connection manner is not limited thereto. For example, in some embodiments, a fixed connection manner such as glue and screw connection may also be used between the brush plate and the handle 1. In this embodiment, a cavity 26 is disposed in the handle 1, and a cover 27 configured to close an opening of the cavity 26 is connected to one end that is of the handle 1 and that is relatively away from the brush head 2. The cover 27 is in clamping fit, plugging fit or threaded connection with the handle 1. It should be noted that the inner brush plate 7 may be stored in the cavity 26 after being disassembled.

The foregoing shows and describes basic principles, main features, and advantages of the present disclosure. Those skilled in the art should understand that the present disclosure is not limited by the above-described embodiments, the above-described embodiments and specification are merely illustrative of the principles of the present disclosure without limiting the present disclosure, various changes and modifications may occur to the present disclosure under the premise of without departing from the spirit and scope of the present disclosure, and these changes and modifications fall within the scope of the present disclosure as claimed. The scope of the present disclosure is defined by the appended claims and equivalents thereof.

What is claimed is:

1. A tongue cleaner, comprising a handle (1) and a brush head (2) disposed at an end thereof, wherein an accommodation tank (3) configured to accommodate a bead and a movable hole (4) in communication with the accommodation tank (3) are formed in the brush head (2), a puncturing member (5) is slidably mounted on the handle (1), and an end thereof is able to enter the movable hole (4) and squeeze the bead in the accommodation tank (3).

2. The tongue cleaner according to claim 1, wherein the brush head (2) comprises an outer brush plate (6) and an inner brush plate (7); the outer brush plate (6) and the handle (1) are connected and are jointly enclosed to form a mounting groove (8); and the inner brush plate (7) is connected to the outer brush plate (6) or the handle (1) and is suspended in the mounting groove (8), and a scraping groove (9) is formed between the inner brush plate (7) and the outer brush plate (6).

3. The tongue cleaner according to claim 2, wherein the inner brush plate (7) and the handle (1) are connected and are jointly enclosed to form a through groove (10); the movable hole (4) is formed in a side wall that is of the inner brush plate (7) and that faces the through groove (10); and at least a part of the puncturing member (5) is located in the through groove (10).

4. The tongue cleaner according to claim 3, wherein the puncturing member (5) comprises a connecting seat (11) slidably connected to the handle (1) and an extrusion plate (12) fastened to the connecting seat (11) and located in the through groove (10), and the extrusion plate (12) corresponds to a position of the movable hole (4).

5. The tongue cleaner according to claim 4, wherein the accommodation tank (3) comprises two bead holes (13) disposed side by side and in communication with each other; and a recess (14) is disposed in the middle of one end that is of the extrusion plate (12) and that faces the movable hole (4), and extrusion protrusions (15) corresponding to positions of the two bead holes (13) are formed on two sides thereof.

6. The tongue cleaner according to claim 4, wherein a socket (16) with a U-shaped cross section is disposed on the connecting seat (11), and a front end of the handle (1) is provided with a plugging portion (17) that is in sliding fit with the socket (16).

7. The tongue cleaner according to claim 6, wherein a positioning groove (18) is disposed on the plugging portion (17), and a positioning protrusion (19) that is in clamping fit with the positioning groove (18) is disposed on an inner wall of the socket (16); and when the positioning protrusion (19) is clamped with the positioning groove (18), an end of the extrusion portion is located outside the movable hole (4).

8. The tongue cleaner according to claim 2, wherein hooks (20) are disposed on two sides of a front end of the handle (1), and slots (21) that are adapted to the hooks (20) in shapes are disposed on two ends of the inner brush plate (7).

9. The tongue cleaner according to claim 2, wherein a cavity (26) is disposed in the handle (1), and a cover (27) configured to close an opening of the cavity (26) is connected to one end that is of the handle (1) and that is relatively away from the brush head (2).

10. The tongue cleaner according to claim 2, wherein the outer brush plate (6) comprises a curved scraper portion (22) and a pair of connecting arms (23) connected to two sides of the scraper portion (22), and the outer brush plate (6) is connected to the handle (1) by using the connecting arms (23); and plugging holes (24) are respectively formed in two sides of a front end of the handle (1), and plugging plates (25) that are adapted to the plugging holes (24) in shapes are respectively disposed on ends of the two connecting arms (23).
